(19) United States
(12) Patent Application Publication
(10) Pub. No.: US 2020/0169001 A1
(43) Pub. Date: May 28, 2020

(54) INDOOR AND OUTDOOR SMALL YAGI ANTENNA WITH A PLURALITY OF INSTALLATION FORMS

(71) Applicant: Jiangxi Innovation Technology Co., Ltd., Ji'an (CN)

(72) Inventors: Jinzhong Lin, Quanzhou (CN); Qin Li, Ganzhou (CN)

(21) Appl. No.: 16/550,337

(22) Filed: Aug. 26, 2019

(30) Foreign Application Priority Data
Nov. 26, 2018 (CN) 201821951050.8

(51) Int. Cl. H01Q 19/04; H01Q 1/22; H01Q 1/12

(52) U.S. Cl. CPC H01Q 19/04; H01Q 1/1242; H01Q 1/1221; H01Q 1/2283

(57) ABSTRACT

The present application provides an indoor and outdoor small Yagi antenna with a plurality of installation forms, comprising an antenna body built-in with a PCBA board and a support member mounted in combination therewith, the support member includes a hanging wall member, a side suction installation member, a pole installation member or an upright installation member; the hanging wall member includes a main board body provided with a hanging hole, and one or more support legs bent and extending from the main board body; the side suction installation member includes a suction disk seat, a first metal shaping tube and a first connecting seat, the pole installation member includes a pole seat, a second metal shaping tube and a second connecting seat, the pole seat includes a seat body and a plurality of U-bolts.

### CROSS REFERENCE TO RELATED APPLICATIONS

The present application claims the benefit of Chinese Patent Application No. 201821951050.8 filed on Nov. 26, 2018, the contents of which are incorporated herein by reference in their entirety.

### TECHNICAL FIELD

The present application belongs to the technical field of wireless communication, and specifically relates to an indoor and outdoor small Yagi antenna with a plurality of installation forms.

### TECHNICAL BACKGROUND

Due to the larger size of the traditional high-gain TV Yagi antenna, the installation thereof requires a specific antenna bracket and a pole, at the same time, due to the directional characteristics of the Yagi antenna, it is inconvenient to adjust the orientation and the angle of the antenna after installation. In addition, due to the size and shape thereof, a user can only choose to install the antenna in an outdoor location such as a top floor of a building, the outdoor environment and various weather factors make the use time and service life of Yagi antennas greatly reduced, in order to different installation positions, the Yagi antenna installation structure in the prior art is also relatively simple, and there are no considerations for a plurality of installation forms.

### SUMMARY

In order to overcome the defects in the prior art, the present application provides an indoor and outdoor small Yagi antenna with a plurality of installation forms, which can meet the positioning requirements of a plurality of installation positions, and the specific technical contents thereof are as follows:

An indoor and outdoor small Yagi antenna with a plurality of installation forms includes an antenna body with a built-in PCBA board and a support member mounted in combination with the antenna body, wherein the support member includes a hanging wall member and a side suction installation member, a pole installation member or an upright installation member.

The hanging wall member includes a main board body provided with a hanging hole, and one or more support legs bent and extending from the main board body;

The side suction installation member includes a suction disk seat, a first metal shaping tube and a first connecting seat, wherein two ends of the first metal shaping tube are connected to the suction disk seat and the first connecting seat, respectively, adjust the orientation of the first connecting seat by the own directional bending thereof and are absorbed fixedly by the suction disk seat on a plane.

The pole installation member includes a pole seat, a second metal shaping tube and a second connecting seat, wherein two ends of the second metal shaping tube are connected to the pole seat and the second connecting seat, respectively and adjust the orientation of the second connecting seat by the directional bending thereof, the pole seat includes a seat body and a plurality of u-shaped bolts, the seat body has a plurality of through holes corresponding to the u-shaped bolts thereon, and the two legs of the u-shaped bolt pass through the through holes and are limited by a nut.

The upright installation member includes a bracket base, a bracket rod and a third connecting seat, wherein the bracket rod is arranged on the bracket base, and the third connecting seat is arranged at a top end thereof.

The antenna body has a signal director, a signal reflector and a main antenna oscillator, and a bottom surface or a side surface thereof is provided with an installation caulking groove in which the support leg of the hanging wall member is embedded, and the bottom surface of the antenna body is provided with a female seat abutting the first connecting base, the second connecting seat and the third connecting seat.

In one or more embodiments of the present application, the bracket base is provided with a suction cup, and the support rod is the third metal shaping tube, and the bracket base is fixedly absorbed with a horizontal plane by the suction cup, and the orientation of the third connecting seat is adjusted by the own directional bending of the third metal shaping tube.

In one or more embodiments of the present application, the bottom surface of the seat body of the pole seat has a longitudinal or/and lateral cylindrical recess.

In one or more embodiments of the present application, the support leg of the hanging wall member includes a lateral section perpendicular to the main board body and extending from an upper edge of the main body, and a vertical section perpendicular to the lateral section and extending upward from the lateral section, the installation caulking groove is located at a bottom edge of the antenna body.

In one or more embodiments of the present application, the connecting female seat has an installation screw hole, the first connecting seat and the second connecting seat and the third connecting seat include a catch joint and a middle joint, respectively, the catch joint has a plurality of claws, the middle joint has a cylinder body and a connecting beam arranged at one end of the cylinder body, a gap is provided between the connecting beam and an opening at the end of the cylinder body, the connecting beam is provided thereon with the through hole, and is connected to the connecting female seat by a screw; the catch joint is penetrated from one end of the cylinder body, and the claw thereof passes out of the other end thereof and grasps firmly the edge of the opening to realize catch engagement.

In one or more embodiments of the present application, the connecting female seat is provided thereon with a limiting bump, and the connecting beam has a hole position into which the limiting bump is embedded.

Compared with the prior art, the present application has the advantages that the antenna body cooperates with the detachable support member, and is suitable for the placement and use on a wall, a table surface, a glass surface, a support rod, etc., and is specially designed with a side suction installation member, the pole installation member or the upright installation member of the metal shaping tube, when the metal shaping tube is applied with a certain force, the angle of the metal shaping tube can be arbitrarily changed so that the antenna can be installed at an arbitrary angle, thereby solving the problem of the directional characteristic use of the Yagi antenna. Meanwhile, in order to improve the convenience of the replacement of the support member, the connecting female seat has an installation screw hole thereon, and the first connecting seat, the second connecting seat and the third connecting seat include the catch joint and the middle joint, respectively, the catch joint has a plurality of claws, the middle joint has a cylinder body and a connecting beam arranged at one end of the cylinder body, a gap is provided between the connecting beam and an opening at the end of the cylinder body, the connecting beam is provided thereon with the through hole, and is connected to the connecting female seat by a screw; the catch joint is penetrated from one end of the cylinder body, and the claw passes out of the other end thereof and grasps firmly the edge of the opening to realize catch engagement.

### BRIEF DESCRIPTION OF DRAWINGS

FIG. 1 is a schematic structural view (top surface) of an antenna body of the present application.

FIG. 2 is a schematic structural view (bottom surface) of an antenna body of the present application.

FIG. 3 is a schematic view (top surface) of an assembly structure of an antenna body and a hanging wall member of the present application.

FIG. 4 is a schematic view (bottom surface) of an assembly structure of an antenna body and a hanging wall member of the present application.

FIG. 5 is a schematic structural view of a hanging wall member of the present application.

FIG. 6 is a schematic view (top surface) of an assembly structure of an antenna body and a side suction installation member of the present application.

FIG. 7 is a schematic view showing the assembly structure (bottom surface) of an antenna body and a side suction installation member of the present application.

FIG. 8 is a schematic view showing the structure of the first connecting seat of the side suction installation member of the present application.

FIG. 9 is a schematic view of an assembly structure of a first connecting seat and a connecting female seat of the present application.

FIG. 10 is a schematic view (top surface) of an assembly structure of an antenna body and a pole installation member of the present application.

FIG. 11 is a schematic view (bottom surface) of an assembly structure of an antenna body and a pole installation member of the present application.

FIG. 12 is a schematic view (top surface) of an assembly structure of an antenna body and an upright installation member of the present application.

FIG. 13 is a schematic view (bottom surface) of an assembly structure of an antenna body and an upright installation member of the present application.

### DETAILED DESCRIPTION

The solution of the present application is further described below with reference to the accompanying drawings:

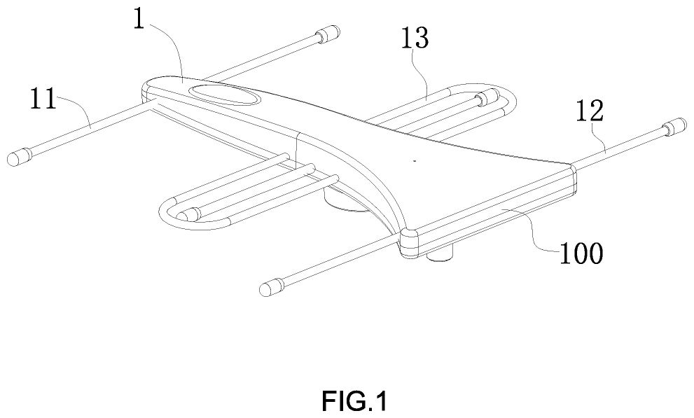

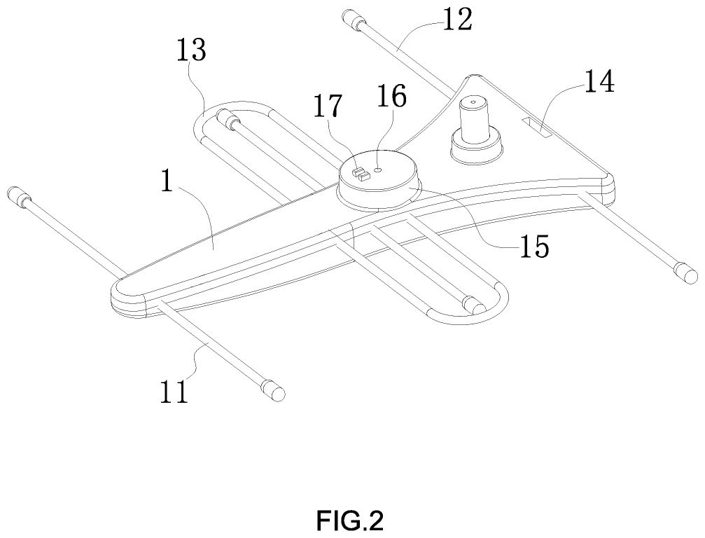

Referring to FIGS. 1 to 2, an indoor and outdoor small Yagi antenna with a plurality of installation forms includes an antenna body 1 built in with a PCBA board and a support member mounted in combination with the antenna body 1, the support member includes a hanging wall member 2, a side suction installation member 3, the pole installation member 4 or the upright installation member 5. The antenna body 1 has a signal director 11, a signal reflector 12 and a main antenna oscillator 13, a bottom edge of the antenna body 1 is provided with an installation caulking groove 14 for cooperating with the hanging wall member 2, and an connecting female seat abutting the side suction installation member 3, the pole installation member 4 or the upright installation member 5, one side of the antenna body 1 on which the installation slot 4 is provided has a flat side 100, and the connecting female seat 15 is provided with an installation screw hole 16 and a plurality of limiting bumps 17.

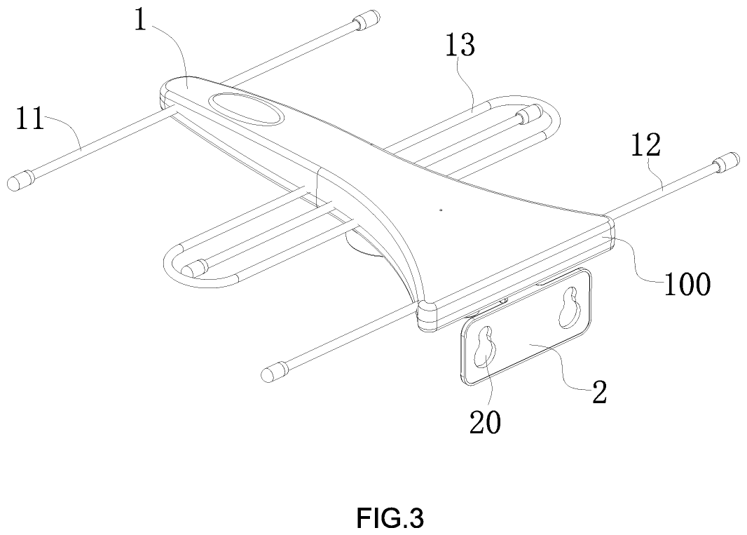

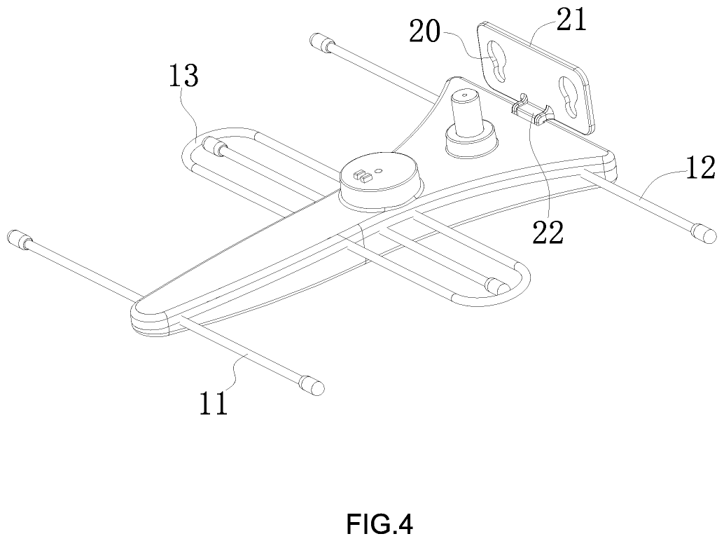

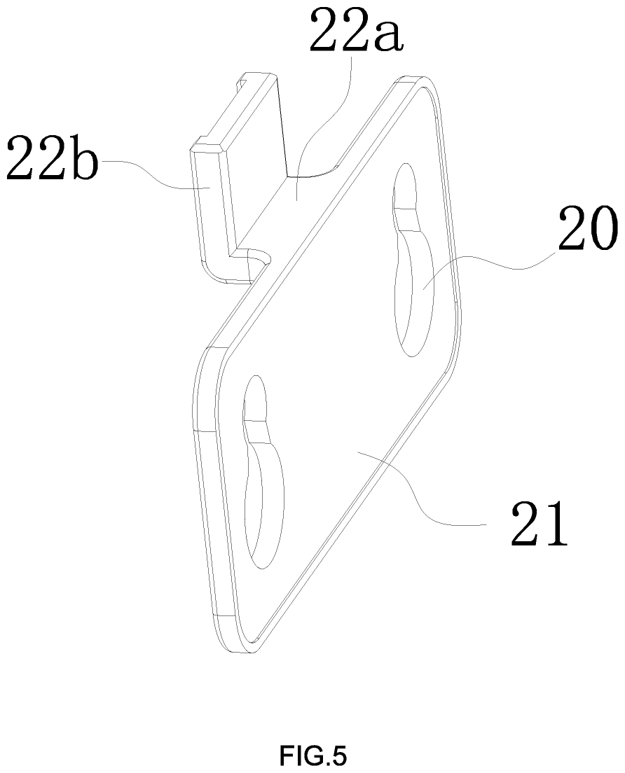

Referring to FIGS. 3 to 5, the hanging wall member 2 includes a main board body 21 provided with a hanging hole 20, and one support leg 22 bent and extending out of the main board body 21, the support leg 22 includes a lateral section 22a perpendicular to the main board body 21 and extending out of an upper edge of the main board body 21, and a vertical section 22b perpendicular to the lateral section 22a and extending upward from the lateral section 22a, a wall body is screwed, the main board body 21 of the hanging wall member is aligned with the screw and pushed from a large hole of a hanging hole 20 to a small hole thereof, and then the installation caulking groove 14 of the antenna body 1 is aligned with the vertical section 22b of the support leg 22 to be embedded therein to realize support.

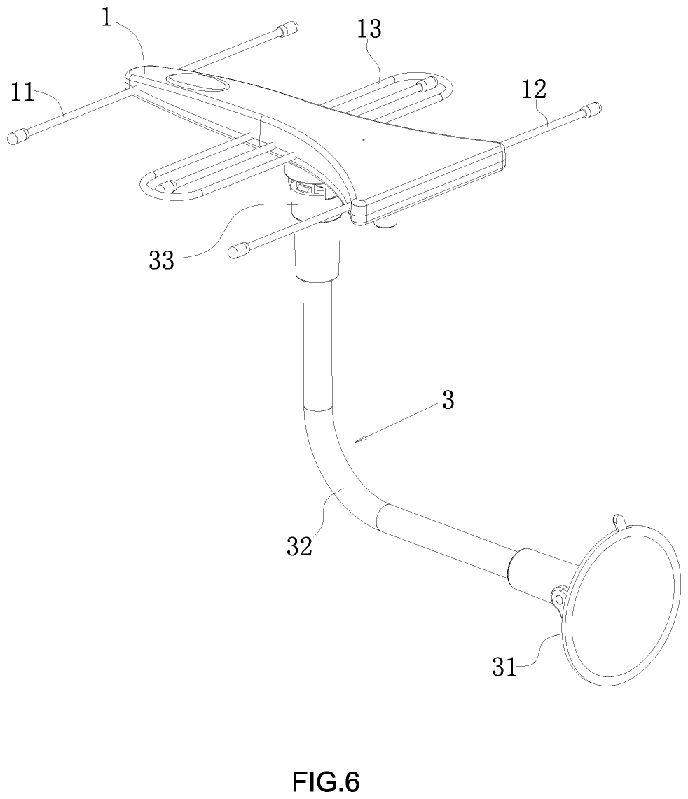

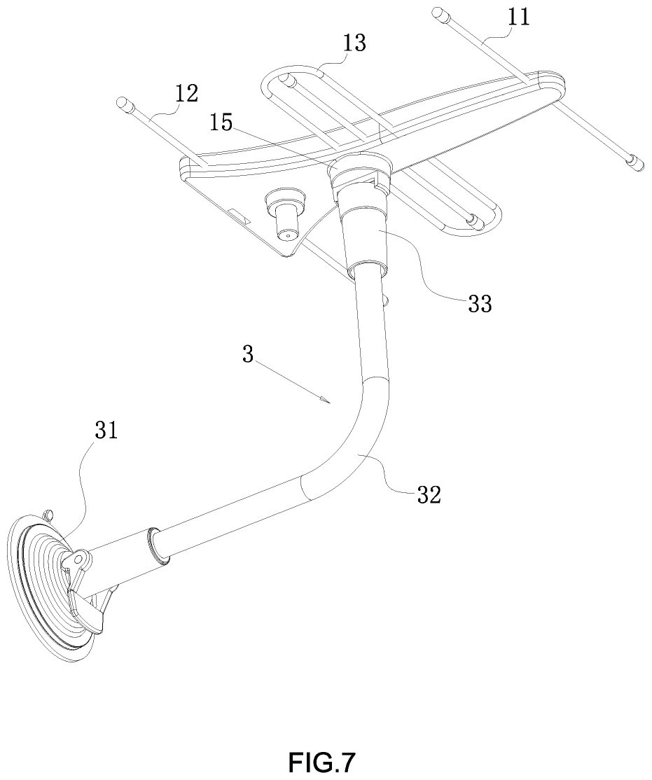

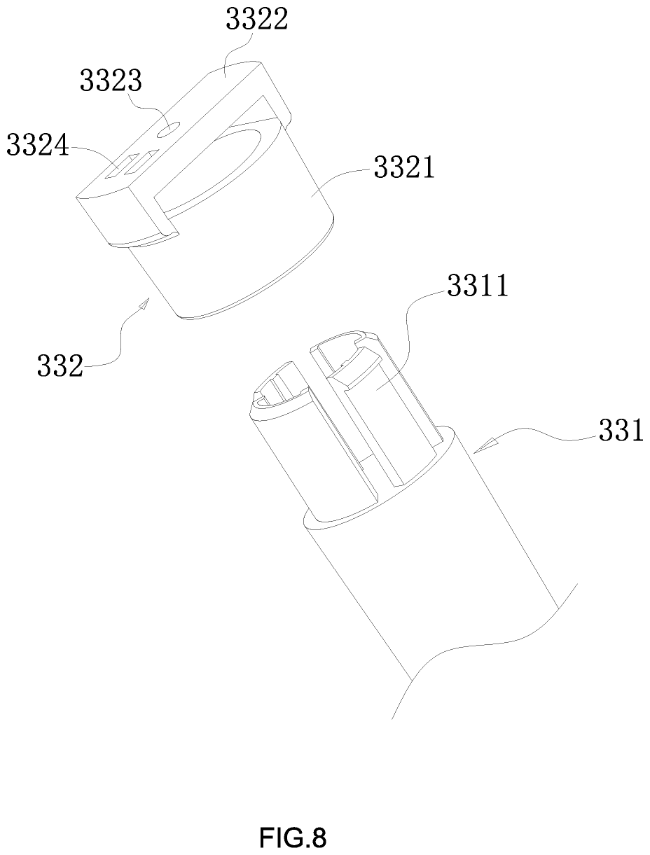

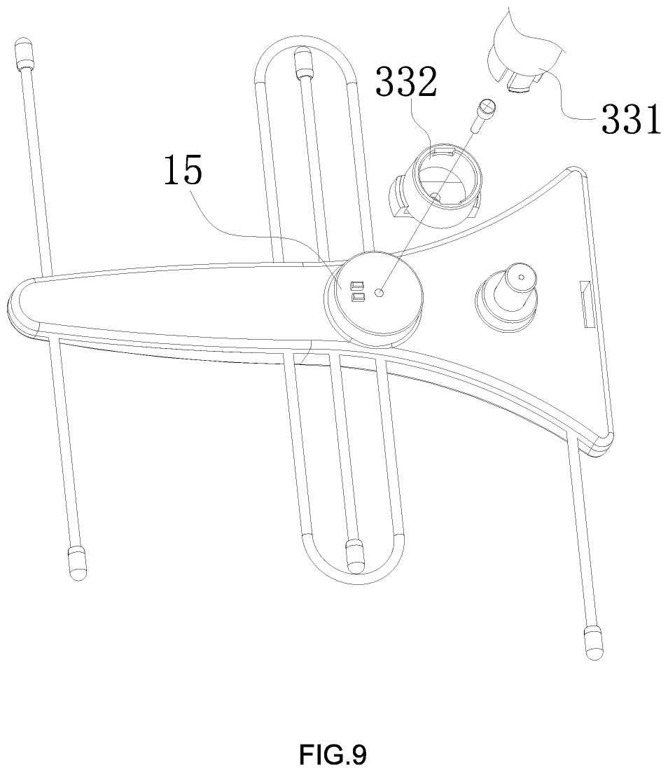

Referring to FIGS. 6 to 9, the side suction installation member 3 includes a suction disk seat 31, a first metal shaping tube 32 and a first connecting seat 33, and two ends of the first metal shaping tube 32 are connected to the suction disk seat 31 and the first connecting seat 33, respectively and adjust the orientation of the first connecting seat 33 by the own directional bending thereof, and absorbed fixedly fixed by the suction disk seat 31 on a plane; the first connecting seat 33 includes a catch joint 331 and an middle joint 332, the catch joint 331 has a plurality of claws 3311. The middle joint 332 has a cylindrical body 3321 and a connecting beam 3322 arranged at one end of the cylindrical body 3321, a gap is provided between the connecting beam 3322 and an opening at the end of the cylindrical body 3321, the connecting beam 3322 is provided thereon with a through hole 3323, and is connected to the connecting female seat 16 by a screw; the catch joint 331 is penetrated from one end of the cylindrical body 3321, and the claw 3311 thereof is passed out of the other end thereof and grasps firmly the edge of the opening to realize catch engagement. The connecting beam 3322 is further provided with a hole position 3324 in which the limiting bump 17 is embedded to prevent the antenna body 1 from rotating.

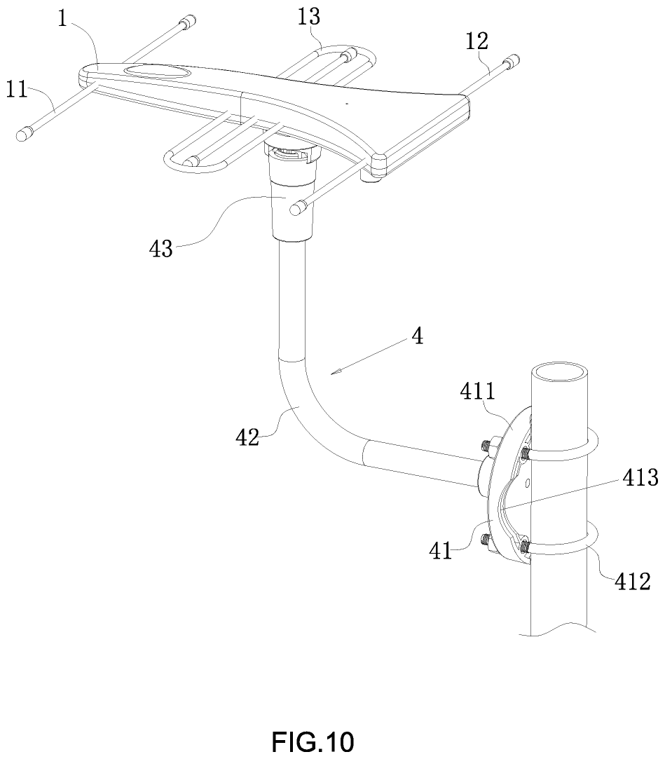

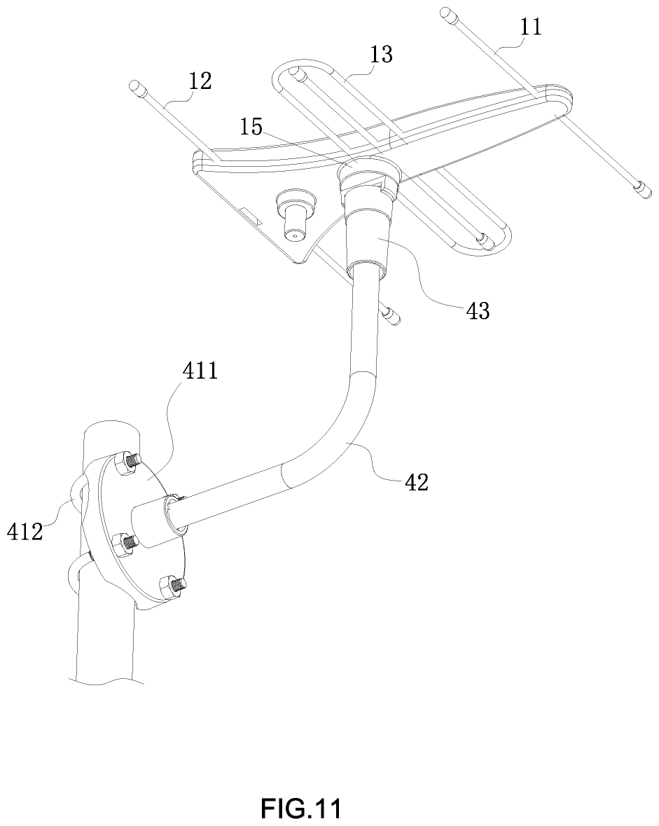

Referring to FIGS. 10 to 11, the pole installation member 4 includes a pole seat 41, a second metal shaping tube 42 and a second connecting seat 43, the two ends of the second metal shaping tube 42 are connected to the pole seat 41 and the second connecting seat 43, respectively and adjust the orientation of the second connecting seat 43 by the own directional bending thereof, the pole seat 41 includes a seat body 411 and a plurality of U-shaped bolts 412, the seat body 411 has a plurality of through holes corresponding to the U-shaped bolts 412 thereon, two legs of the U-shaped bolt 412 pass through the through holes and are limited by a nut; the bottom surface of the seat body 411 of the pole seat 41 has a longitudinal or/and lateral cylindrical recess 413; the structure of the second connecting base 43 is the same as that of the first connecting base 33 described above.

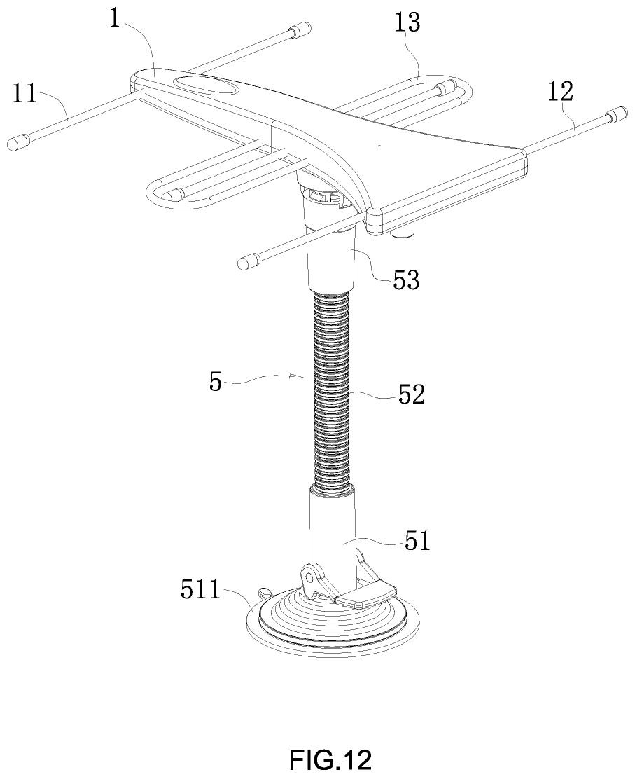

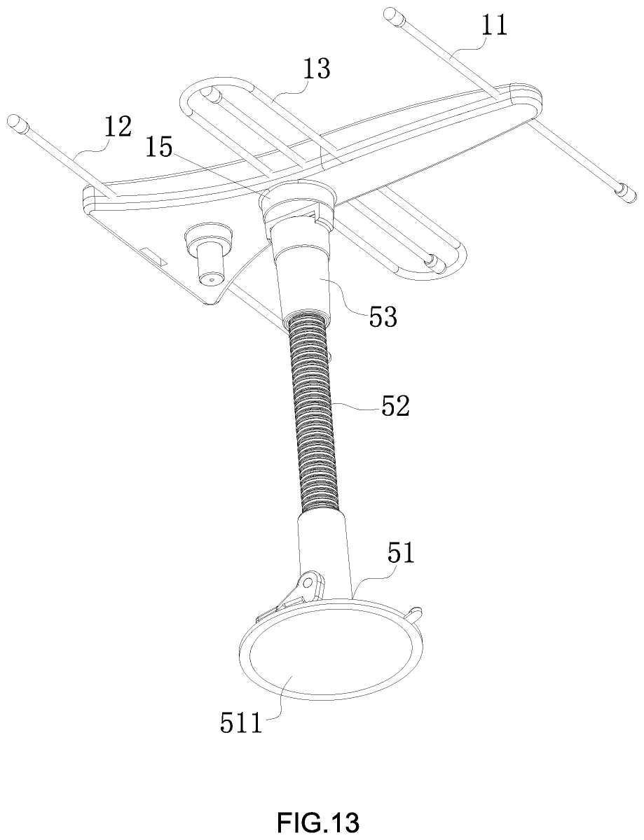

Referring to FIGS. 12 to 13, the upright installation member 5 includes a bracket base 51, a bracket rod 52, and a third connecting seat 53, the bracket rod 52 is arranged on the bracket base 51, and the top end thereof is provided with the third connecting seat 53; the bracket base 51 is provided with a suction disk 511, the bracket rod 52 is a third metal shaping tube, the bracket base 51 is fixedly attached to a horizontal plane by the suction disk 511, and adjusts the orientation of the third connecting base by the own directional bending of the third metal shaping tube (the seat rod 52); the structure of the third connecting seat 53 is the same as that of the first connecting seat 33 described above.

The above-mentioned preferred embodiments are to be considered as illustrative of the embodiments of the solution of the present application, and any technical derivation, replacement, improvement, etc., which are based on the same, approximate or based on the solution of the present application, should be regarded as the protection scope of the present patent.

What is claimed is:

1. An indoor and outdoor small Yagi antenna with a plurality of installation forms, comprising: an antenna body with a built-in PCBA board and a support member mounted in combination with the antenna body, wherein the support member comprises a hanging wall member and a side suction installation member, a pole installation member or an upright installation member;
the hanging wall member comprises a main board body provided with a hanging hole, and one or more support legs bent and extending from the main board body;
the side suction installation member comprises a suction disk seat, a first metal shaping tube and a first connecting seat, wherein two ends of the first metal shaping tube are connected to the suction disk seat and the first connecting seat, respectively, adjust the orientation of the first connecting seat by the own directional bending thereof and are absorbed fixedly by the suction disk seat on a plane;
the pole installation member comprises a pole seat, a second metal shaping tube and a second connecting seat, wherein two ends of the second metal shaping tube are connected to the pole seat and the second connecting seat, respectively and adjust the orientation of the second connecting seat by the directional bending thereof, the pole seat comprises a seat body and a plurality of U-shaped bolts, the seat body has a plurality of through holes corresponding to the U-shaped bolts thereon, and the two legs of the U-shaped bolt pass through the through holes and are limited by a nut;
the upright installation member comprises a bracket base, a bracket rod and a third connecting seat, wherein the bracket rod is arranged on the bracket base, and the third connecting seat is arranged at a top end thereof;
the antenna body has a signal director, a signal reflector and a main antenna oscillator, and a bottom surface or a side surface thereof is provided with an installation caulking groove in which the support leg of the hanging wall member is embedded, and the bottom surface of the antenna body is provided with a female seat abutting the first connecting base, the second connecting seat and the third connecting seat.

2. The indoor and outdoor small Yagi antenna with the plurality of installation forms according to claim 1, wherein the bracket base is provided with a suction cup, and the support rod is the third metal shaping tube, and the bracket base is fixedly absorbed with a horizontal plane by the suction cup, and the orientation of the third connecting seat is adjusted by the own directional bending of the third metal shaping tube.

3. The indoor and outdoor small Yagi antenna with the plurality of installation forms according to claim 1, wherein the bottom surface of the seat body of the pole seat has a longitudinal or/and lateral cylindrical recess.

4. The indoor and outdoor small Yagi antenna with the plurality of installation forms according to claim 1, wherein the support leg of the hanging wall member comprises a lateral section perpendicular to the main board body and extending from an upper edge of the main body, and a vertical section perpendicular to the lateral section and extending upward from the lateral section, the installation caulking groove is located at a bottom edge of the antenna body.

5. The indoor and outdoor small Yagi antenna with the plurality of installation forms according to claim 1, wherein the connecting female seat has an installation screw hole, the first connecting seat and the second connecting seat and the third connecting seat comprise a catch joint and a middle joint, respectively, the catch joint has a plurality of claws, the middle joint has a cylinder body and a connecting beam arranged at one end of the cylinder body, a gap is provided between the connecting beam and an opening at the end of the cylinder body, the connecting beam is provided thereon with the through hole, and is connected to the connecting female seat by a screw; the catch joint is penetrated from one end of the cylinder body, and the claw thereof passes out of the other end thereof and grasps firmly the edge of the opening to realize catch engagement.

6. The indoor and outdoor small Yagi antenna with the plurality of installation forms according to claim 2, wherein the connecting female seat has an installation screw hole, the first connecting seat and the second connecting seat and the third connecting seat comprise a catch joint and a middle joint, respectively, the catch joint has a plurality of claws, the middle joint has a cylinder body and a connecting beam arranged at one end of the cylinder body, a gap is provided between the connecting beam and an opening at the end of the cylinder body, the connecting beam is provided thereon with the through hole, and is connected to the connecting female seat by a screw; the catch joint is penetrated from one end of the cylinder body, and the claw thereof passes out of the other end thereof and grasps firmly the edge of the opening to realize catch engagement.

7. The indoor and outdoor small Yagi antenna with the plurality of installation forms according to claim 3, wherein the connecting female seat has an installation screw hole, the first connecting seat and the second connecting seat and the third connecting seat comprise a catch joint and a middle joint, respectively, the catch joint has a plurality of claws, the middle joint has a cylinder body and a connecting beam arranged at one end of the cylinder body, a gap is provided between the connecting beam and an opening at the end of the cylinder body, the connecting beam is provided thereon with the through hole, and is connected to the connecting female seat by a screw; the catch joint is penetrated from one end of the cylinder body, and the claw thereof passes out of the other end thereof and grasps firmly the edge of the opening to realize catch engagement.

8. The indoor and outdoor small Yagi antenna with the plurality of installation forms according to claim 4, wherein the connecting female seat has an installation screw hole, the first connecting seat and the second connecting seat and the third connecting seat comprise a catch joint and a middle joint, respectively, the catch joint has a plurality of claws, the middle joint has a cylinder body and a connecting beam arranged at one end of the cylinder body, a gap is provided between the connecting beam and an opening at the end of the cylinder body, the connecting beam is provided thereon with the through hole, and is connected to the connecting female seat by a screw; the catch joint is penetrated from one end of the cylinder body, and the claw thereof passes out of the other end thereof and grasps firmly the edge of the opening to realize catch engagement.

9. The indoor and outdoor small Yagi antenna with the plurality of installation forms according to claim 5, wherein the connecting female seat is provided thereon with a limiting bump, and the connecting beam has a hole position into which the limiting bump is embedded.

10. The indoor and outdoor small Yagi antenna with the plurality of installation forms according to claim 6, wherein the connecting female seat is provided thereon with a limiting bump, and the connecting beam has a hole position into which the limiting bump is embedded.

11. The indoor and outdoor small Yagi antenna with the plurality of installation forms according to claim 7, wherein the connecting female seat is provided thereon with a limiting bump, and the connecting beam has a hole position into which the limiting bump is embedded.

12. The indoor and outdoor small Yagi antenna with the plurality of installation forms according to claim 8, wherein the connecting female seat is provided thereon with a limiting bump, and the connecting beam has a hole position into which the limiting bump is embedded.
